(19) United States
(12) Patent Application Publication
(10) Pub. No.: US 2006/0042597 A1
(43) Pub. Date: Mar. 2, 2006

(54) FUEL INJECTION APPARATUS INCLUDING DEVICE FOR SUPPRESSING PRESSURE WAVES IN RESERVOIR INJECTION SYSTEMS

(76) Inventor: Hans-Christoph Magel, Pfullingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/527,586

(22) PCT Filed: Jun. 16, 2003
(86) PCT No.: PCT/DE03/01999

§ 371 Date: Mar. 14, 2005

(30) Foreign Application Priority Data
Oct. 4, 2002 (DE) 102 46 208.9

(51) Int. Cl. F02M 57/02

(52) U.S. Cl. 123/446

(57) ABSTRACT

A fuel injection apparatus has a pressure booster located between a high-pressure reservoir and a nozzle chamber. A high-pressure chamber of this fuel injection apparatus communicates with the pressure line with a control chamber which actuates an injection valve member of a fuel injector and with the nozzle chamber. A compensation device is connected to a high-pressure line between the high-pressure reservoir and the fuel injector produces a throttled connection or an unthrottled connection between the high-pressure reservoir and the fuel injector.

### FIELD OF THE INVENTION

Both pressure-controlled and stroke-controlled injection systems can be used to supply fuel to combustion chambers of self-igniting internal combustion engines. Besides unit fuel injectors and pump-line units, reservoir injection systems (common rails) are also used. Common rails advantageously make it possible for instance to adapt the injection pressure to the load and rpm of the engine. To achieve high specific outputs and to reduce emissions, the highest possible injection pressure is generally required.

### BACKGROUND OF THE INVENTION

For reasons of strength, the attainable pressure level in reservoir injection systems (common rails) in current use is at present limited to about 1800 bar. To further increase the pressure in reservoir injection systems, a pressure booster can be used in common rail systems.

German Patent Disclosure DE 199 10 970 A1 discloses a fuel injection apparatus. The fuel injection apparatus has a booster unit, located between a pressure reservoir and a nozzle chamber, whose pressure chamber communicates with the nozzle chamber via a pressure line. A bypass line connected to the pressure reservoir is also provided. The bypass line communicates directly with the pressure line. The bypass line can be used for a pressurized injection and is located parallel to the pressure chamber, so that regardless of the motion and position of a displaceable pressure medium in the pressure booster unit, the bypass line is passable. This embodiment offers the capability of meterable preinjection with low tolerances, by means of a slight or in other words unboosted injection pressure. By switching over between injection pressures, a flexible postinjection or a plurality of postinjections at high or low injection pressure can be realized.

The triggering of a pressure booster produces a pressure fluctuation in the line between the pressure booster and the high-pressure reservoir, which results in an unwanted course of the injection pressure. During the injection, large quantities of fuel are drawn from the high-pressure reservoir. The resultant injection pressure course is characterized by a pronounced pressure maximum and an ensuing pressure drop toward the end of injection. This injection pressure course leads to poorer the emissions in self-igniting internal combustion engines and high peak loads on the components. The resultant pressure elevation is chronologically limited and is inadequate for the injection times required for utility vehicles, for instance, so that toward the end of injection, an unwanted pressure drop occurs. By means of a throttle associated with the high-pressure reservoir, the pressure wave can indeed be suppressed during the injection, but a pressure drop then occurs at the throttle, and as a result the attainable injection pressure and efficiency of the fuel injection system are still reduced.

### SUMMARY OF THE INVENTION

With the compensation device proposed according to the invention between a high-pressure reservoir and a fuel injector, the pressure fluctuations that occur when fuel is withdrawn from the high-pressure reservoir can be reduced. The compensation device eliminates a pressure disappearance that occurs at the onset of an injection event, and it prevents a pressure drop both during injection and in injection phases that follow the injection. The injection pressure and the system efficiency of the fuel injection system are unimpaired by the compensation device. Upon triggering of a pressure booster of a fuel injector, or triggering of a fuel injector, the abrupt withdrawal of a quantity causes an underpressure wave, which travels from the fuel injector or pressure booster over the line to the high-pressure reservoir. The underpressure wave is reflected, at the end of the line toward the high-pressure reservoir, in the form of an overpressure wave, which can be utilized to increase the injection pressure level at the fuel injector. This superelevation of pressure is chronologically limited, however, and decreases again toward the end of the injection phase. Particularly in self-igniting internal combustion engines used in utility vehicles, because of the longer injection time, the pressure drop toward the end of the injection phase worsens emissions considerably.

With the compensation device, which is received in the line system between the high-pressure reservoir (common rail) and the fuel injector—whether it is embodied with or without a pressure booster—the pressure fluctuation can be broken down, but a pressure drop toward the end of the injection phase or at the onset of the subsequent injections can also be avoided. This is attained by providing that the onset of injection, a throttled connection exists between the high-pressure line and the fuel injector and serves to break down the pressure fluctuations, while after a delay that is required for the break down of the pressure fluctuation, an unthrottled connection between the high-pressure reservoir and the fuel injector, or the pressure booster of the fuel injector, is opened. Thus in the injection phase, once the pressure fluctuation has been broken down, the high fuel pressure prevailing in the high-pressure reservoir is also present at the fuel injector, or at the pressure booster of the fuel injector. Thus not only can peak loads on the component, in terms of the stresses occurring upon pressure fluctuations, be avoided, but a pressure drop toward the end of the injection phase or at the onset of subsequent injections can be suppressed, which very favorably influences the emissions of self-igniting internal combustion engines. The throttle cross section between the line and the high-pressure source or high-pressure reservoir is designed such that only slight reflection, if any, of the underpressure wave at the end of the line occurs.

### DRAWING

The invention is described in further detail below in conjunction with the drawing.

Shown are:

FIG. 1, a first variant embodiment of the compensation device proposed according to the invention, with throttle restrictions located outside a compensation element; and

FIG. 2, a further variant embodiment of the compensation device proposed according to the invention, in which throttle restrictions are integrated with the compensation element.

### VARIANT EMBODIMENTS

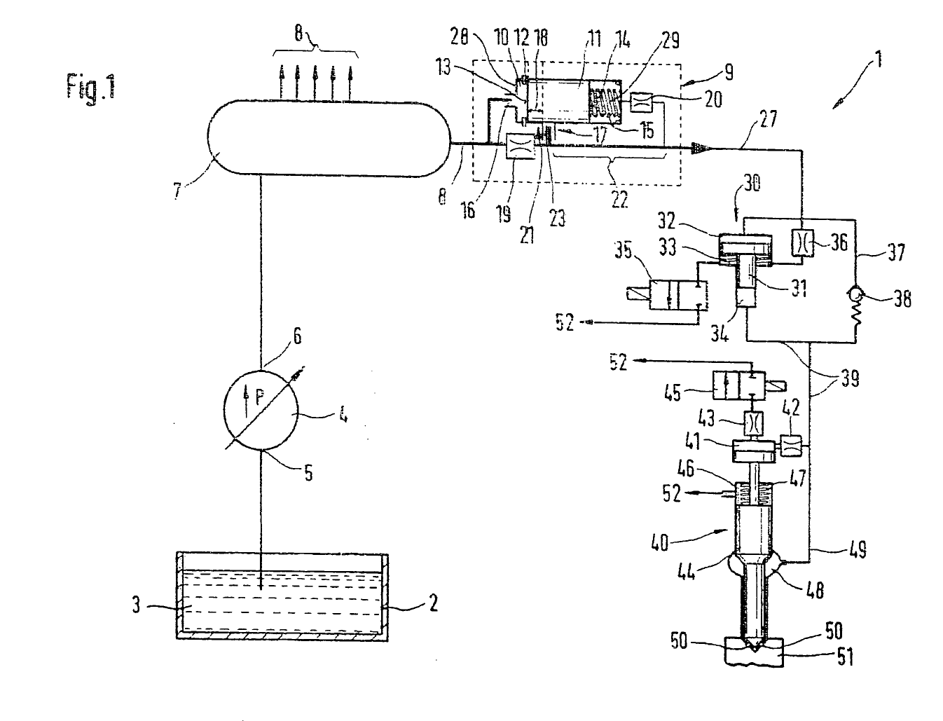

FIG. 1 shows a first variant embodiment of the compensation device proposed according to the invention, in which the throttle restrictions are located outside the compensation device.

In the first exemplary embodiment of the fuel apparatus of the invention shown in FIG. 1, a fuel injection system 1 includes a fuel tank 2, which is filled with fuel 3. From the fuel tank 2, the fuel 3 is pumped via a fuel pump 4. The fuel 3 enters the fuel pump 4 at a low-pressure side 5 and leaves the fuel pump 4 at a high-pressure side 6. By means of the fuel pump 4, the fuel 3 is delivered to a high-pressure reservoir 7 (common rail), in which fuel pressures of up to 16 bar prevail. On the outside of the high-pressure reservoir 7, high-pressure line connections 8 are located, in a number corresponding to the number of cylinders of the self-igniting engine to be supplied with fuel. Via each of the high-pressure connections 8 schematically shown in FIG. 1, fuel at high pressure is delivered to one high-pressure line 27, which extends from the high-pressure reservoir 7 to a pressure booster 30 or to a fuel injector 40.

Although variant embodiments of the compensation device proposed according to the invention are described below that are used in fuel injectors 40 with a pressure booster 30, the compensation device described in further detail below can also be employed with fuel injectors that do not include any pressure booster. The compensation device proposed according to the invention is used in fuel injectors with a pressure booster 30 in which, and in injection, an especially high volumetric flow of fuel out of the reservoir occurs. Conversely, it is also possible to use the compensation device proposed according to the invention in fuel injectors without a pressure booster that have high injection quantities.

A compensation device 9 proposed according to the invention is integrated with the high-pressure line 27 that extends from each high-pressure line connection 8 of the high-pressure reservoir 7 to the fuel injector 40, or to a fuel injector with an associated pressure booster 30. In the first exemplary embodiment, shown in FIG. 1, of a compensation device 9, the compensation device 9 includes a housing 28. A compensation element 11 embodied in pistonlike fashion is located movably inside the housing 28. The compensation element has a first face end 13 and a second face end 14. The pistonlike compensation element 11 is prestressed by a prestressing spring 15 that acts inside the housing 28 on the second face end 14 of the pistonlike compensation element 11. The prestressing spring 15 is braced on the face end of the housing 28 diametrically opposite the second face end 14. In the region of this face end, a stop element may be located for the second face end 14 of the pistonlike compensation element 11. The prestressing spring 15 is received inside a differential pressure chamber 29 of the housing 28. A further, second throttle restriction 20 located outside the housing 28 is associated with the differential pressure chamber 29 of the housing 28 and discharges into the high-pressure line 27. A first throttle restriction 19, also located outside the housing 28, is furthermore located in the high-pressure line 27 between the high-pressure reservoir 7 and the pressure booster 30.

The first throttle restriction 19, located in the high-pressure line 27 between the high-pressure reservoir 7 and the pressure booster 30, is connected parallel to a compensation chamber 10 of the compensation device 9. The compensation chamber 10 is filled with fuel that is at high pressure via a line segment branching off from the high-pressure line 27, and this fuel enters the compensation chamber 10 at an inlet 16. A stop 12 for the first face end 13 of the pistonlike compensation element 11 is received inside the compensation chamber 10. The stop 12 may for instance be embodied as a ring or the like that is let into the wall of the housing 28. Accordingly, the compensation chamber 10 of the compensation device 9 is defined by the first face end 13 of the pistonlike compensation element 11 and by the face end of the housing 28 that receives the inlet 16.

In the exemplary embodiment of FIG. 1, the compensation device 9 includes an outlet 17, which extends between the housing 28 and the high-pressure line 27 to the pressure booster 30 or to the fuel injector 40. The outlet 17 is embodied as a slide 21, by way of which a slide opening 23 can be opened or closed. Once a stroke length identified by reference numeral 18 is overcome, the compensation element 11 that is located inside the housing 28 uncovers the slide opening 23 either partially or completely, depending on the pressure relief of the differential pressure chamber 29, and thus establishes an unthrottled connection between the high-pressure reservoir 7 and the pressure booster 30 or the fuel injector 40, as will be described in further detail below.

Downstream of both the first throttle restriction 19 received in the high-pressure line 27 and of the outlet 17, the compensation device 9 may include a throttling segment, which is identified by reference numeral 22. As indicated by the arrow in FIG. 1, the fuel at high pressure, stored in the high-pressure reservoir 7, flows from the compensation device 9 via the high-pressure line 27 to a pressure booster 30. The pressure booster 30 includes a pistonlike booster element 31 acted upon by a spring. The pistonlike booster element 31 acts on a high-pressure chamber 34. The pressure booster 30 furthermore includes a work chamber 32, identified by reference numeral 32, and a differential pressure chamber 33. A differential pressure chamber throttle 36 precedes the differential pressure chamber 33 of the pressure booster 30. Connected parallel to the pressure booster 30, which is actuatable via a 2/2-way valve that can for instance be embodied as a magnet valve, is a bypass line 37, which includes a check valve 38. The actuation of the pressure booster 30 is effected by means of a pressure relief of the differential pressure chamber 33 of the pressure booster 30 upon switching of the 2/2-way valve 35. If this valve is connected to a return 52 that discharges into the fuel tank 2, then flows out of the differential pressure chamber 33, in which a spring element acting on the pistonlike booster element 31 may be located, into the return 52. The pistonlike booster element 31 thereupon moves into the high-pressure chamber 34. As a result, fuel is pumped into a further pressure line 39, which changes over in the region of the fuel injector 40 into a nozzle inlet 49. The pressure level produced by the pressure booster 30 in its high-pressure chamber 34 exceeds the pressure level which prevails inside the high-pressure reservoir 7 that is acted upon by the fuel pump 4.

A return flow of the fuel, flowing out of the high-pressure chamber 34 into the further high-pressure line 39, to the high-pressure reservoir 7 via the high-pressure line 27 is prevented by the check valve 38 contained in the bypass line 37. Via the further high-pressure line 39, the fuel, whose pressure is elevated in accordance with the pressure boosting ratio of the pressure booster 30, is present via an inlet throttle 42 in a control chamber 41 as well as in a nozzle chamber 48 of the fuel injector 40. The control chamber 41, by way of which the motion of an injection valve member 44 of the fuel injector 40 is controlled, can be pressure-relieved via an outlet throttle 43, which in turn can be made to communicate with the return 52 via a switching valve 45, which may likewise be embodied as a magnet valve. The outlet throttle 43 is shown only schematically in the view shown in FIG. 1 and can be embodied for instance by a ball element forced into a valve seat, by way of which element an outflow of control volume from the control chamber 41 can be controlled.

The fuel injector 40 includes, besides the control chamber 41, a nozzle spring chamber 46, in which a nozzle spring 47 is received. The nozzle spring 47 is braced on one end on the injector body of the fuel injector 40 and on the other on an annular face of the injection valve member 44. The nozzle chamber 48 is located below the nozzle spring chamber 46. A pressure shoulder is embodied in the region of the nozzle chamber 48, on the injection valve member 44—which is embodied for instance as a nozzle needle. Via the nozzle chamber inlet 49, into which the further high-pressure line 39 changes, fuel that is at elevated fuel pressure is introduced into the nozzle chamber 48, which upon pressure relief of the control chamber 41 via the outlet throttle 43 and the effectiveness of the hydraulic area of the pressure shoulder brings about an opening motion of the injection valve member 44. As a result of the opening motion of the injection valve member 44, injection openings 50 are uncovered, which discharge into a combustion chamber, identified by reference numeral 51, of a self-igniting internal combustion engine, which however is shown only schematically here.

The mode of operation of the compensation device proposed according to the invention, inside the high-pressure line 27 between the high-pressure reservoir 7 (common rail) and a pressure booster 30 of the fuel injector 40 will now be described:

The triggering of the pressure booster 30 is effected via the 2/2-way valve 35; the triggering of the fuel injector 40 is effected by actuation of the switching valve 45. To assure an elevated fuel pressure, that is, a fuel pressure which is above the fuel level prevailing in the high-pressure reservoir 7, the pressure booster 30 may be triggered slightly earlier than the fuel injector 40 in terms of the onset of injection. Upon triggering of the pressure booster 30, an underpressure wave occurs in the high-pressure line 27 between the high-pressure reservoir 7 and the pressure booster 30, because a greater fuel volume suddenly flows out of the high-pressure line 27. A reflection of the underpressure wave that occurs upon the onset of injection at the end, toward the high-pressure reservoir 7, of the high-pressure line 27 is suppressed by the first throttle restriction 19, which in the first exemplary embodiment of the compensation device 9 proposed according to the invention is located outside the housing 28. However, since the first throttle restriction 19 by itself would lead an excessively great pressure drop during the injection, a pressure difference becomes operative at the pistonlike compensation element 11 of the compensation device 9 when the slide 21 is closed. The compensation chamber 10, by way of which the first face end 13 of the pistonlike compensation element 11 is acted upon, is connected parallel to the first throttle restriction 19. Because of the pressure drop at the first throttle restriction 19 and because of the pressure prevailing via the at the inlet 16 in the high-pressure reservoir 7, the pistonlike compensation element 11 is moved in the opening direction, counter to the action of the prestressing spring 15. Once a stroke length 18 in the opening direction has been overcome, the slide 21 that is formed by the housing 28 and a top region of the pistonlike compensation element 11 opens, and as a result a slide opening 23 is uncovered. The opening speed of the pistonlike compensation element 11 is adjusted by the cross section of the second throttle restriction 20 located outside the differential pressure chamber 29. By way of the dimensioning of the second throttle restriction 20, a delay in uncovering the slide opening 23 can be attained. The length of this delay is adjusted such that the reflection of the underpressure wave is avoided. If the pistonlike compensation element 11 uncovers the slide opening 23 once the stroke length 18 has been overcome, then a larger flow cross section is opened up between the high-pressure line 27 and the high-pressure reservoir 7. Because of this, in subsequent injection phases, no pressure loss occurs at the first throttle restriction 19. To stabilize the opening phase or in other words the response phase of the pistonlike compensation element 11, the compensation device 9 may include a throttling segment 22, which in terms of the inflow direction of the fuel with respect to the pressure booster 30, can be downstream of the first throttle restriction 19 and can be embodied either outside or inside the compensation device 9. Accordingly, at the onset of injection and immediately after the injection, there is a throttled connection between the high-pressure line 27 and the high-pressure reservoir 7, via the first throttle restriction 19, while after a length of delay that can be adjusted by means of the dimensioning of the second throttle restriction 20, there is an unthrottled connection between the high-pressure reservoir 7 and the high-pressure line 27 toward the pressure booster 30, via the slide opening 23 that is now in the opened position.

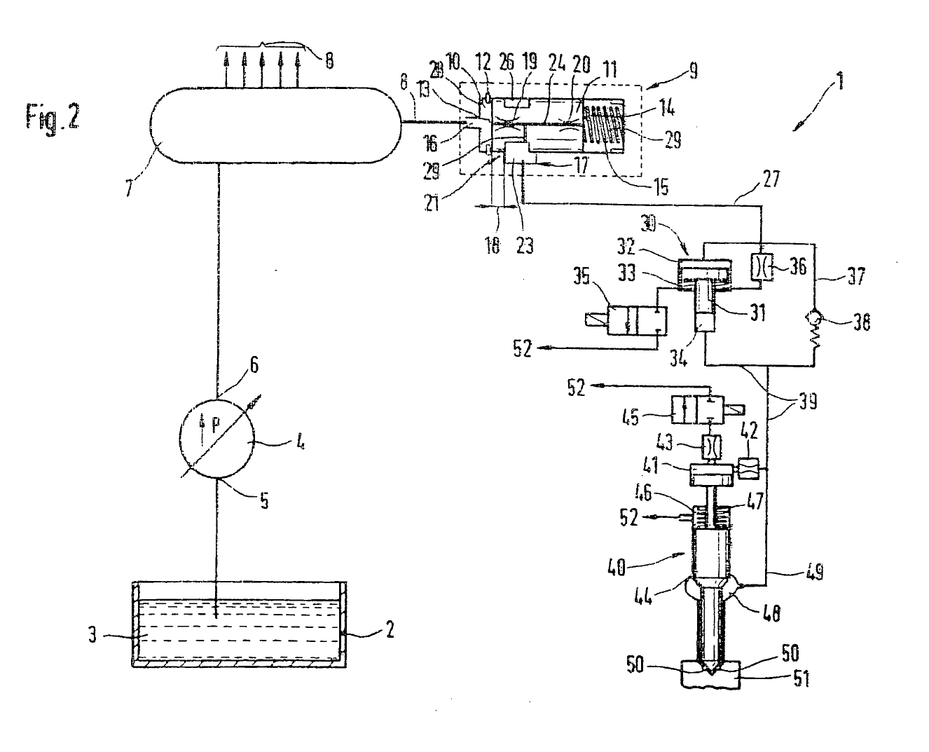

FIG. 2 shows a further exemplary embodiment of the compensation device proposed according to the invention, in which the throttle restrictions are integrated with the compensation element. In the exemplary embodiment shown in FIG. 2, fuel 3 is pumped from the fuel tank 2 into the high-pressure reservoir 7 via the fuel pump 4. The high-pressure side of the fuel pump 4 is identified by reference numeral 6 and the low-pressure side of the fuel pump by reference numeral 5. A plurality of fuel line connections 8 are provided on the high-pressure reservoir 7, and they correspond in number to the number of chambers 51 of the engine to be supplied with fuel.

Unlike the first exemplary embodiment, shown in FIG. 1, of the compensation device 9 proposed, in the exemplary embodiment shown in FIG. 2 both the first throttle restriction 19 and the second throttle restriction 20 are integrated with the pistonlike compensation element 11. The pistonlike compensation element 11 has a first face end 13 and a second face end 14. The second face end 14 is engaged by a prestressing spring 15, which is braced on the side of the housing 28 diametrically opposite the second face end 14. The housing 28 surrounds the compensation element 11. By means of the compensation element 11, the housing 28 is divided into the compensation chamber 10 and the differential pressure chamber 29. The stop, which can be embodied annularly, for the first face end 13 of the pistonlike compensation element 11 is let into the compensation chamber 10. At the inlet 16, the compensation chamber 10 is acted upon directly via the high-pressure line connection 8 of the high-pressure reservoir 7 by fuel that is at high pressure.

The pistonlike compensation element 11, in the exemplary embodiment shown in FIG. 2, is penetrated by a conduit 24, inside which both the first throttle restriction 19 and the further, second throttle restriction 20 are embodied. The conduit 24 represents a flow connection between the compensation chamber 10 and the differential pressure chamber 29 of the compensation device 9. Beginning at the conduit 24, a branch 25 extends that discharges in an annular chamber 26 embodied on the circumferential face of the pistonlike compensation element 11. The length of the annular chamber 26 at the circumferential face of the pistonlike compensation element 11 is equivalent to the axial length—relative to the housing 28—of the slide opening 23 on the housing 28. Reference numeral 18 indicates the stroke length that must initially be overcome by the pistonlike compensation element 11 before an unthrottled connection is created between the high-pressure reservoir 7 and the high-pressure line 27. The slide opening 23 represents the outlet 17 of the housing 28 of the compensation device 9.

From the outlet 17, the high-pressure line 27 extends to the pressure booster 30. Via the high-pressure line 27, the differential pressure chamber throttle 36, which is associated with the pressure booster 30, is acted upon by fuel at high pressure, which flows into the differential pressure chamber 33 of the pressure booster 30 via the differential pressure chamber throttle 36. At the same time, the work chamber 32 of the pressure booster 30 is also acted upon by fuel at high pressure. The pistonlike booster element 31 acts on the high-pressure chamber 34 of the pressure booster 30. An actuation of the pressure booster 30 is effected by pressure relief of the differential pressure chamber 33, upon actuation of the 2/2-way valve 35 that is in communication with the fuel tank 2 via a return 52. The bypass line 37, in which a check valve 38 is received, is connected parallel to the pressure booster 30.

From the high-pressure chamber 34 of the pressure booster 30, a further high-pressure line 39 extends to the fuel injector 40. On the end of the fuel injector 40 toward the combustion chamber, the further high-pressure line 39 changes over into the nozzle chamber inlet 49. Via the further high-pressure line 39, the control chamber 41 is acted upon directly by fuel via the inlet throttle 42 and the nozzle chamber 48, and this fuel is—in comparison to the pressure level of the high-pressure reservoir 7—at a still further-elevated pressure. The fuel at still-further elevated pressure flows via the inlet throttle 42 into the control chamber 41, which can be pressure-relieved via the outlet throttle 43. For pressure relief of the control chamber 41—and thus for actuation of the injection valve member 44 of the fuel injector 40—the actuation of the switching valve 45 of the outlet throttle 43 is effected, which valve can be embodied as a magnet valve and likewise communicates, via a return line 52, with the fuel tank 2 of the fuel injection system 1.

The fuel injector 40 furthermore includes a nozzle spring chamber 46, in which a nozzle spring 47 is received. The nozzle spring 47 is braced on one end on an annular face of the injection valve member 44; on the other, the nozzle spring 47 rests on an annular face that defines the nozzle spring chamber 46. The nozzle spring chamber 46 likewise communicates with the return 52.

The injection valve member 44, which as a result of the pressure relief of the control chamber 41 upon actuation of the switching valve 45 executes a reciprocating motion, has a pressure shoulder in the region of the nozzle chamber 48. An annular gap inside the injector body of the fuel injector 40 extends from the nozzle chamber 48 to the end toward the combustion chamber of the fuel injector 40. The fuel flows via the annular gap to injection openings 50, by way of which the fuel is injected into the combustion chamber 51 of the self-igniting internal combustion engine upon opening of the injection valve member 44.

For injection of fuel into the combustion chamber 51 of the self-igniting engine, triggering of the pressure booster 30 is effected, via the 2/2-way valve 35, which may be embodied as a magnet valve. As a result, a pressure relief of the differential pressure chamber 33 of the pressure booster 30 is effected into the return 52. The pistonlike booster element 31 of the pressure booster 30 moves into the high-pressure chamber 34. Parallel to, or with a slight chronological offset from, the triggering of the 2/2-way valve 35 of the pressure booster 30, triggering of the switching valve 45 is effected, for pressure relief of the control chamber 41 of the fuel injector 40.

Upon triggering of the pressure booster 30, a pressure fluctuation occurs in the high-pressure line 27 between the pressure booster 30 and the high-pressure reservoir 7. By means of the compensation device 9 proposed according to the invention, a reflection of the underpressure wave on the end of the high-pressure line 27 pointing toward the high-pressure reservoir 7 (common rail) is suppressed by means of the first throttle restriction 19 integrated with the pistonlike compensation element 11. With the pressure booster 30 triggered, fuel flows out of the compensation chamber 10 via the throttle restriction 19 and the branch 25 into the annular chamber 26 into the high-pressure line 27. Because of the resultant pressure drop at the throttle 19, a pressure difference is created between the compensation chamber 10 and the differential pressure chamber 29. Via the high-pressure line connection 8 of the high-pressure reservoir 7, which connection acts on the inlet 16 of the compensation chamber 10, the pressure level that prevails inside the high-pressure reservoir 7 acts on the first face end 13 of the pistonlike compensation element 11. The slide 21, formed by the top region of the pistonlike compensation element 11 and the wall of the housing 28 of the compensation device 9, is initially closed. Because of the higher pressure inside the compensation chamber 10, which pressure acts on the first face end 13 of the pistonlike compensation element 11, the pistonlike compensation element 11 is displaced in the opening direction, counter to the prestressing spring 15. The opening speed at which the pistonlike compensation element 11 moves inside the housing 28 is determined by the second throttle restriction 20, also located in the conduit 24. Once the stroke length identified by reference numeral 18 is overcome, uncovering of the slide opening 23 is effected, the result being an unthrottled connection between the high-pressure line 27 to the pressure booster 30 and the high-pressure reservoir 7 (common rail). The opening speed of the pistonlike compensation element 11, which speed can be controlled by the dimensioning of the second throttle restriction 20 inside the pistonlike compensation element 11, makes it possible to manufacture an unthrottled connection between the high-pressure line 27 and the high-pressure reservoir 7 only once the reflection of the underpressure wave has been cancelled by the first throttle restriction 19. As a result, in the ensuing injection phases, no pressure loss occurs at the first throttle restriction 19.

With the exemplary embodiment of the compensation device 9 proposed according to the invention and shown in FIG. 2 as well, upon the onset of an injection a throttled connection is established between the high-pressure line 27 and the high-pressure reservoir 27, via the first throttle position 19 that is integrated with the pistonlike compensation element 11. After a delay, the length of which can be adjusted by the dimensioning of the second throttle restriction 20, an unthrottled connection occurs between the high-pressure reservoir 7 and the high-pressure line 27 via the opened slide 21, or in other words as a result of the uncovering of the slide opening 23 in the housing 28, via the compensation chamber 10, by way of which the pressure booster 30 of the fuel injector 40 is acted upon by fuel that is at high pressure.

With both the first exemplary embodiment of FIG. 1 and the second exemplary embodiment of FIG. 2, a breakdown in the pressure fluctuation at the onset of the injection can be achieved, yet a pressure drop during the injection and in ensuing injection phases is averted, so that the injection pressure and system efficiency are not made worse. By using the compensation device 9 proposed according to the invention, an injection pressure course can be attained which compared to former injection pressure courses in fuel injectors with a pressure booster but without a compensation device 9 has smoothed-out pressure maximums and does not have an excessive pressure drop toward the end of the injection. As a result, the emissions of self-igniting internal combustion engines can be significantly improved on the one hand, and on the other the life of the components of the fuel injection system can be lengthened because the peak loads are reduced.

### List of Reference Numerals

1 Fuel injection system
2 Fuel tank
3 Fuel
4 Fuel pump
5 Low-pressure side
6 High-pressure side
7 High-pressure reservoir
8 High-pressure line connection
9 Compensation device
10 Compensation chamber
11 Pistonlike compensation element
12 Stop
13 First face end
14 Second face end
15 Prestressing spring
16 Inlet
17 Outlet
18 Stroke length h₁
19 First throttle restriction (throttled connection)
20 Second throttle restriction
21 Slide (unthrottled connection)
22 Throttling segment
23 Slide opening
24 Through conduit
25 Branch
26 Annular chamber
27 High-pressure line
28 Housing
29 Differential pressure chamber
30 Pressure booster
31 Piston
32 Work chamber
33 Differential pressure chamber
34 High-pressure chamber
35 2/2-way valve
36 Differential pressure chamber throttle
37 Bypass line
38 Check valve
39 Further high-pressure line
40 Fuel injector
41 Control chamber
42 Inlet throttle
43 Outlet throttle
44 Injection valve member
45 Switching valve for outlet throttle
46 Nozzle spring chamber
47 Nozzle spring
48 Nozzle chamber
49 Nozzle chamber inlet
50 Injection opening
51 Combustion chamber
52 Return

1-16. (canceled)

17. A fuel injection apparatus, comprising
a high-pressure reservoir (7) by way of which fuel at high pressure is delivered to a fuel injector (40),
a control chamber (41) actuating an injection valve member (44) of the fuel injector (40) a nozzle chamber (48) surrounding the injection valve member (44),
the high-pressure reservoir (7) and the fuel injector (40) communicating with one another via a high-pressure line (8, 27), and
a compensation device (9) located in the high-pressure line (8, 27) between the high-pressure reservoir (7) and the fuel injector (40), the compensation device (9) establishing either a throttled connection (19) or an unthrottled connection (21) between the high pressure line (8, 27) and the high pressure reservoir (7).

18. The fuel injection apparatus as recited in claim 17, wherein the compensation device (9) comprises a pistonlike compensation element (11) located displaceably inside a housing (28).

19. The fuel injection apparatus as recited in claim 18, wherein the compensation element (11) comprises opposed end faces (13, 14) and is acted upon on one of its face ends (13, 14) by a prestressing spring, which positions the compensation element (11) against a stop (12) located in the housing of the compensation device (9).

20. The fuel injection apparatus of claim 19, wherein the housing (28) includes an inlet (16), by way of which a first face end (13) of the pistonlike compensation element (11) is acted upon by the high fuel pressure level prevailing in the high-pressure reservoir (7).

21. The fuel injection apparatus of claim 18, wherein at the housing comprises an outlet (17) discharging into the high-pressure line (27), and wherein the outlet (17) can be opened by a slide (21), which after overcoming a stroke length (18) opens an unthrottled connection between the high-pressure reservoir (7) and the high-pressure line (27).

22. The fuel injection apparatus of claim 18, wherein the compensation device (9) comprises a first throttle restriction (19), integrated with the high-pressure line (27) and located outside the housing (28), and a second throttle restriction (20), associated with a differential pressure chamber (29) in the housing (28).

23. The fuel injection apparatus of claim 22, wherein the first throttle restriction (19) is connected parallel to a pressure chamber (10) of the housing (28).

24. The fuel injection apparatus of claim 23, wherein the first throttle restriction (19) is located in the high-pressure line (27) between a branch to the inlet (16) and the outlet (17) of the housing.

25. The fuel injection apparatus of claim 22, wherein the opening speed of the compensation element (11) received movably in the housing (28) depends on the throttle cross section of the second throttle restriction (20) located downstream of the differential pressure chamber (29).

26. The fuel injection apparatus of claim 22, further comprising a throttling segment (22) is located in the line (27) downstream of the first throttle restriction (19) and of the outlet (17) of the housing (28) of the compensation device.

27. The fuel injection apparatus of claim 17, further comprising first and second throttle restrictions (19), (20) integrated into the compensation element (11).

28. The fuel injection apparatus of claim 27, wherein the throttle restrictions (19), (20) are embodied in a conduit (24) penetrating the compensation element (11).

29. The fuel injection apparatus of claim 11, wherein the first throttle restriction (19) discharges at a first face end (13) of the compensation element (11) and is in communication, via a branch (25), with an outlet (17) of the housing (28).

30. The fuel injection apparatus of claim 29, wherein the branch (25) discharges at the compensation element (11) in an annular chamber (26), whose axial length is equivalent to that of a slide opening (23) at the outlet (17) of the housing (28).

31. The fuel injection apparatus of claim 17, wherein the fuel injector (40) includes a pressure booster (30) that is integrated with it.

32. The fuel injection apparatus of claim 17, wherein the compensation device (9) is located in the high-pressure line (8, 27) between the high-pressure reservoir (7) and the fuel injector (40), on the end of the high-pressure line (8, 27) toward the high-pressure reservoir.
